(19) United States
(12) Patent Application Publication
(10) Pub. No.: US 2017/0289837 A1
(43) Pub. Date: Oct. 5, 2017

(54) NETWORK OPTIMIZATION AND CLIENT STEERING BASED ON WIRELESS DATA RATE CAPABILITIES OF MIXED CLIENT DEVICES

(71) Applicant: Dell Software Inc., Round Rock, TX (US)

(72) Inventors: Zhuangzhi Duo, Fremont, CA (US); Zhong Chen, San Jose, CA (US)

(21) Appl. No.: 15/085,180

(22) Filed: Mar. 30, 2016

(51) Int. Cl. H04W 28/02; H04L 12/825

(52) U.S. Cl. CPC H04W 28/0268; H04L 47/25

(57) ABSTRACT

A wireless local area network (WLAN) access point may receive a steering policy from a WLAN controller, the steering policy matching various data rate capabilities to various quality of service (QoS) levels. When a client device attempts to connect to the access point (AP), the AP responds via a default virtual access point (VAP) so that the client device transmits its client data rate capability to the AP via association request. The AP then checks the steering policy and either allows the connection to the default VAP if the QoS of the default VAP matches the client data rate or identifies a second VAP (which the AP may generate if it doesn't already exist) whose QoS does match the client data rate. The AP may then initiate WLAN communications between the client device and the matching VAP. Client devices with higher data rate capabilities may thus receive higher priority.

### BACKGROUND OF THE INVENTION

Field of the Invention

The present invention generally relates to performance optimization of client device tasks in mixed wireless network access point environments. More specifically, the present invention relates to prioritizing tasks from client devices with high connection rate capabilities and steering client devices into appropriately prioritized virtual access points based on their connection rate capabilities.

Description of the Related Art

Network-based data communications can be transmitted over a variety of types of localized networks, such as local area networks (LAN), wireless local area networks (WLAN), municipal area networks (MAN), or wide area networks (WAN). Often, these networks may be used to connect to the internet. Network-based data communications are useful for a variety of tasks, such as sending and receiving emails/messages, browsing Internet/intranet pages, downloading and updating software, or communicating via voice and/or video calls/conferences.

Wireless local area networks (WLAN) intended to cover a relatively small area are typically deployed using a single wireless router, where a number of client devices can wirelessly connect to the wireless router to receive and transmit network-based data communications. Wireless local area networks (WLAN) covering a relatively large area might instead be deployed using a centralized WLAN controller (which may itself be a wireless router) communicatively coupled to one or more localized wireless access points (AP), where each of a number of client devices can wirelessly connect to one of the wireless access points (AP) or to the WLAN controller itself. The WLAN controller, the access points (AP), or in some cases the client devices can generate virtual access points (VAP). An access point (AP) or virtual access point (VAP), with its client devices, may sometimes be referred to as a basic service set (BSS), and may be uniquely identified by a service set identification (SSID).

Wireless data communications can be transmitted and received using a number of different wireless communication protocols. Some of the most common wireless communication protocols match the IEEE 802.11 set of standards, which can be used to form private network connections as well as internet-connected network connections. The IEEE 802.11 set of standards includes “legacy” standards, such as 802.11a, 802.11b, and 802.11g. Client devices using these “legacy” standards typically suffer from relatively slow and low-throughput connections as compared to those using more modern standards. The IEEE 802.11 set of standards also includes 802.11n, which is faster and has a higher throughput than the “legacy” standards (i.e., 802.11a/b/g), and 802.11ac, which is faster and has a higher throughput than 802.11n. Recently, 802.11ad (short range, very fast, very high throughput connections) was also added as a standard. In the coming years, more standards are expected to be added to the IEEE 802.11 set of standards, such as 802.11af (TV spectrum, long range, propagates through walls), 802.11ah (slower, long range, low power consumption), 802.11ai (faster initial link setup time), 802.11aj (similar to 802.11ad but using 45 GHz spectrum instead of 60 GHz spectrum), 802.11aq (enables pre-association discovery of services), 802.11ax (planned successor to 802.11ac), 802.11ay (planned successor to 802.11ad). Other wireless protocols may also be used, such as Bluetooth, visible light communications (“VLC”), radio wave (e.g., radio frequency identification or “RFID”), microwave, or audio (e.g., HF, VHF, UHF).

WLAN infrastructure may be deployed in a “legacy mode”, in which every access point behaves like a “legacy” access point (i.e., using only 802.11a/b/g standards) and does not take advantage of speed/throughput boosts of more modern standards. Modern client devices can join access points using “legacy mode,” and thus compatibility is preserved, but speed/throughput are stuck at slow “legacy” levels.

WLAN infrastructure may be deployed in a “greenfield mode,” in which every access point uses a modern standard, such as 802.11ac, and only connects with client devices using the same modern standard. Thus, a 802.11n access point can only connect to 802.11n client devices, and a 802.11ac access point can only connect to 802.11ac client devices. Client devices connected to a “greenfield mode” access point achieve the maximum possible speed/throughput benefits of their respective standards, but compatibility is not preserved, as all communications using a previous standard are perceived as noise to a “greenfield mode” access point.

WLAN infrastructure may be deployed in a “mixed mode,” which is a hybrid solution that allows each access point to connect with multiple client devices using multiple standards based on the capabilities of each client device. Thus, compatibility is preserved, and modern devices are able to take advantage of some of the speed/throughput benefits of the more modern 802.11 standards. However, WLAN system performance of modern client devices in a “mixed mode” WLAN infrastructure is still somewhat decreased when compared to modern client devices in a “greenfield mode” WLAN infrastructure.

Therefore, there is a need for an improved WLAN infrastructure to optimize wireless network connections.

### SUMMARY OF THE CLAIMED SUBJECT MATTER

One exemplary method for wireless network optimization includes receiving a steering policy that identifies matches between a plurality of data rate capabilities and a plurality of quality of service levels. The method also includes receiving an association request from a client device, the association request identifying at least a client data rate capability of the client device. The method also includes identifying, based on the received steering policy, a client quality of service level matching the client data rate capability. The method also includes identifying a matching-quality virtual access point having a virtual access point quality of service level that matches the client quality of service level. The method also includes initiating wireless communications between the client device and the matching-quality virtual access point.

One exemplary system for wireless network optimization includes a communication transceiver communicatively coupled to at least a network controller and client device. The communication transceiver receives a steering policy from the network controller, the steering policy identifying matches between a plurality of data rate capabilities and a plurality of quality of service levels. The communication transceiver receives an association request from the client device, the association request identifying at least a client data rate capability of the client device. The system also includes a memory. The system also includes a processor coupled to the memory and to the communication transceiver. Execution of instructions stored in the memory by the processor performs system operations. The system operations include identifying, based on the received steering policy, a client quality of service level matching the client data rate capability. The system operations also include identifying a matching-quality virtual access point having a virtual access point quality of service level that matches the client quality of service level. The system operations also include initiating wireless communications between the client device and the matching-quality virtual access point.

One exemplary non-transitory computer-readable storage medium may have embodied thereon a program executable by a processor to perform a method for wireless network optimization. The exemplary program method includes receiving a steering policy that identifies matches between a plurality of data rate capabilities and a plurality of quality of service levels. The program method also includes receiving an association request from a client device, the association request identifying at least a client data rate capability of the client device. The program method also includes identifying, based on the received steering policy, a client quality of service level matching the client data rate capability. The program method also includes identifying a matching-quality virtual access point having a virtual access point quality of service level that matches the client quality of service level. The program method also includes initiating wireless communications between the client device and the matching-quality virtual access point.

### BRIEF DESCRIPTION OF THE FIGURES

FIG. 1A is a chart illustrating an exemplary inefficient data prioritization of four tasks from four client devices, each with different connection rate capabilities.

FIG. 1B is a chart illustrating an exemplary efficient data prioritization of four tasks from four client devices, each with different connection rate capabilities.

FIG. 2A illustrates an exemplary wireless local area network (WLAN) environment with client steering disabled.

FIG. 2B illustrates an exemplary wireless local area network (WLAN) environment with client steering enabled and with a first steering policy.

FIG. 2C illustrates an exemplary wireless local area network (WLAN) environment with client steering enabled and with a second steering policy.

FIG. 2D illustrates an exemplary wireless local area network (WLAN) environment with client steering enabled and with a third steering policy.

FIG. 3 is a swim-lane flow diagram illustrating exemplary client steering operations between a wireless local area network (WLAN) controller, a wireless access point (AP), and a client device.

FIG. 4 is a table illustrating an exemplary client steering policy identifying various quality of service (QoS) groupings.

FIG. 5 is a block diagram of an exemplary computing device that may be used to implement an embodiment of the present invention.

### DETAILED DESCRIPTION

A wireless local area network (WLAN) access point may receive a steering policy from a WLAN controller, the steering policy matching various data rate capabilities to various quality of service (QoS) levels. When a client device attempts to connect to the access point (AP), the access point responds via a default virtual access point (VAP) so that the client device transmits its client data rate capability to the AP via association request. The AP then checks the steering policy and either allows the connection to the default virtual access point if the quality of service of the default virtual access point matches the client data rate or identifies a second virtual access point (which the access point may generate if it doesn't already exist) whose quality of service does match the client data rate. The access point may then initiate WLAN communications between the client device and the matching virtual access point. Client devices with higher data rate capabilities may thus receive higher priority.

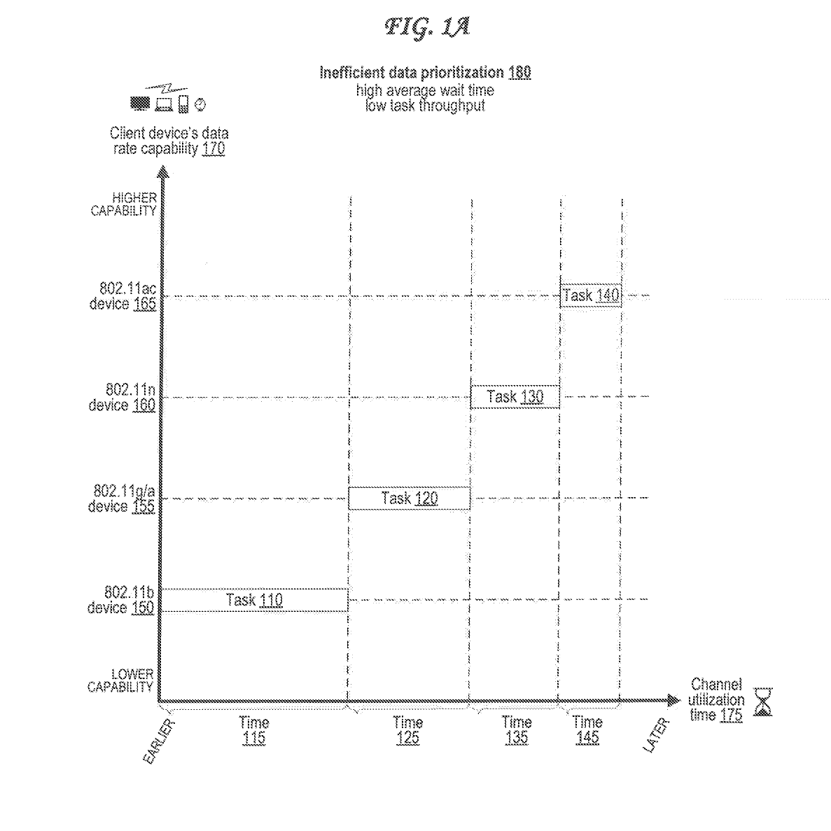

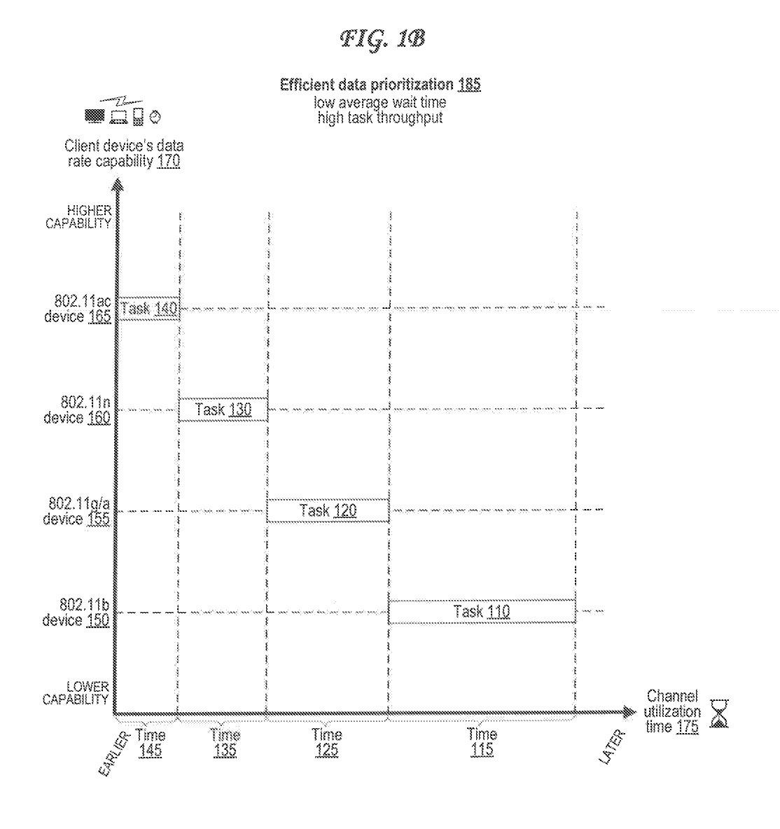

FIG. 1A is a chart illustrating an exemplary inefficient data prioritization of four tasks from four client devices, each with different connection rate capabilities.

The inefficient data prioritization 180 arranges a number of exemplary tasks (i.e., task 110, task 120, task 130, task 140) from a number of exemplary client devices (i.e., 802.11b device 150, 802.11g/a device 155, 802.11n device 160, 802.11ac device 165) in a manner that front-loads the tasks with the longest channel utilization time 175 (e.g. task 110), causing high average wait times for each of the client devices, and causing low total task throughput.

The client devices (i.e., 802.11b device 150, 802.11g/a device 155, 802.11n device 160, 802.11ac device 165) charted in FIG. 1A are charted according to data rate capability 170. A client device's “data rate capability” 170 as used in FIG. 1A describes can be used to describe data rate capabilities, transfer speed capabilities, connection speed capabilities, throughput capabilities, bandwidth capabilities, download speed capabilities, upload speed capabilities, latency capabilities, connection rate capabilities, data signaling rate capabilities, bit rate capabilities, basic service rate capabilities, basic supported rate capabilities, or some combination thereof. In one exemplary embodiment, the 802.11b device 150 may have an average data rate of 11 megabits per second (Mbps), the 802.11g/a device 155 may have an average data rate of 54 Mbps, the 802.11n device 160 may have an average data rate of 450 Mbps, and the 802.11ac device 165 may have an average data rate of 1.3 gigabits per second (Gbps). These data rates should be understood to be exemplary rather than limiting.

The chart of FIG. 1A illustrates a set of tasks (i.e., task 110, task 120, task 130, task 140) executed by these identified client devices. The tasks performed by the devices with lower data rate capabilities 170 take longer to perform as identified by the time measurements (i.e., time 115, time 125, time 135, time 145) along the bottom axis of the chart.

In particular, the chart of FIG. 1A illustrates a task 110 from the 802.11b device 150 whose duration of channel utilization time 175 is a lengthy time 115. The chart of FIG. 1A also illustrates a task 120 from the 802.11g or 802.11a device 155 whose duration of channel utilization time 175 is a somewhat lengthy time 125. The chart of FIG. 1A also illustrates a task 130 from the 802.11n device 160 whose duration of channel utilization time 175 is a somewhat shorter time 135. The chart of FIG. 1A also illustrates a task 140 from the 802.11ac device 165 whose duration of channel utilization time 175 is a short time 145. Thus, in the chart of FIG. 1A, time 115 is greater than time 125, which is greater than time 135, which is greater than time 145. It should be understood that these are exemplary tasks and exemplary devices representing a subset of the possible client device data rate capabilities 170—relative speeds and throughputs for client devices using 802.11ad, 802.11af, 802.11ah, 802.11ai, 802.11aj, 802.11aq, 802.11ax, 802.11ay, or other wireless protocols (e.g., Bluetooth, VLC, radio-wave, microwave, audio) could be similarly charted based on their respective speeds and throughput rates.

An average waiting time for the tasks of FIG. 1A using the inefficient prioritization 180 of FIG. 1A can be calculated using the following formula:

AWT_{FIG}_{_}_{1A}=((3*time115)+(2*time125)+time135)/4

A total task throughput for all of the tasks of FIG. 1A using the inefficient prioritization 180 of FIG. 1A can be calculated using the following formula:

TT_{FIG}_{_}_{1A}=4/((3*time115)+(2*time125)+time135)

FIG. 1B is a chart illustrating an exemplary efficient data prioritization of four tasks from four client devices, each with different connection rate capabilities.

In particular, the chart of FIG. 1B charts the same exemplary tasks (i.e., task 110, task 120, task 130, task 140) from the same exemplary client devices (i.e., 802.11b device 150, 802.11g/a device 155, 802.11n device 160, 802.11ac device 165) but arranges them according to an efficient data prioritization 185 that front-loads the tasks with the shortest channel utilization time 175 (e.g. task 140), causing low average wait times for each of the client devices, and causing high task throughput.

An average waiting time for the tasks of FIG. 1A and FIG. 1B using the efficient prioritization 185 of FIG. 1B can be calculated using the following formula:

AWT_{FIG}_{_}_{1B}=((3*time145)+(2*time135)+time125)/4

The average waiting time using the efficient prioritization 185 of FIG. 1B, denoted as AWT_{FIG}_{_}_{1B}, is clearly shorter than the average waiting time using the inefficient prioritization 180 of FIG. 1A, denoted as AWT_{FIG}_{_}_{1A} because the highest multipliers in the numerator are switched to the shortest times instead of the longest times, ultimately decreasing the result. In particular, time 145 (the shortest time) has the largest multiplier (×3) in the numerator in the AWT_{FIG}_{_}_{1B} calculation, whereas time 115 (the longest time) has the largest multiplier (×3) in the numerator in the AWT_{FIG}_{_}_{1A} calculation. Similarly, time 135 (the second-shortest time) has the second-largest multiplier (×2) in the numerator in the AWT_{FIG}_{_}_{1B} calculation, whereas time 115 (the second-longest time) has the second-largest multiplier (×2) in the numerator in the AWT_{FIG}_{_}_{1A} calculation. Because of this:

AWT_{FIG}_{_}_{1B}<AWT_{FIG}_{_}_{1A}

A total task throughput for all of the tasks of FIG. 1A and FIG. 1B using the efficient prioritization 185 of FIG. 1B can be calculated using the following formula:

TT_{FIG}_{_}_{1B}=4/((3*time145)+(2*time135)+time125)

The total task throughput using the efficient prioritization 185 of FIG. 1B, denoted as TT_{FIG}_{_}_{1B}, is clearly larger than the total task throughput using the inefficient prioritization 180 of FIG. 1A, denoted as TT_{FIG}_{_}_{1A}, for the same reasons that the efficient prioritization 185 of FIG. 1B results in a shorter average waiting time. In particular, the highest multipliers in the denominator are switched to the shortest times instead of the longest times, ultimately increasing the result. In particular, time 145 (the shortest time) has the largest multiplier (×3) in the denominator in the TT_{FIG}_{_}_{1B} calculation, whereas time 115 (the longest time) has the largest multiplier (×3) in the denominator in the TT_{FIG}_{_}_{3A} calculation. Similarly, time 135 (the second-shortest time) has the second-largest multiplier (×2) in the denominator in the TT_{FIG}_{_}_{1B} calculation, whereas time 115 (the second-longest time) has the second-largest multiplier (×2) in the denominator in the TT_{FIG}_{_}_{3A} calculation. Because of this:

TT_{FIG}_{_}_{1B}>TT_{FIG}_{_}_{1A}

Either the inefficient prioritization 180 of FIG. 1A or the efficient prioritization 185 of FIG. 1B can be practiced at the level of a wireless local area network (WLAN) in its entirety, such as at a wireless router or WLAN controller, or more locally at a physical WLAN access point or virtual WLAN access point.

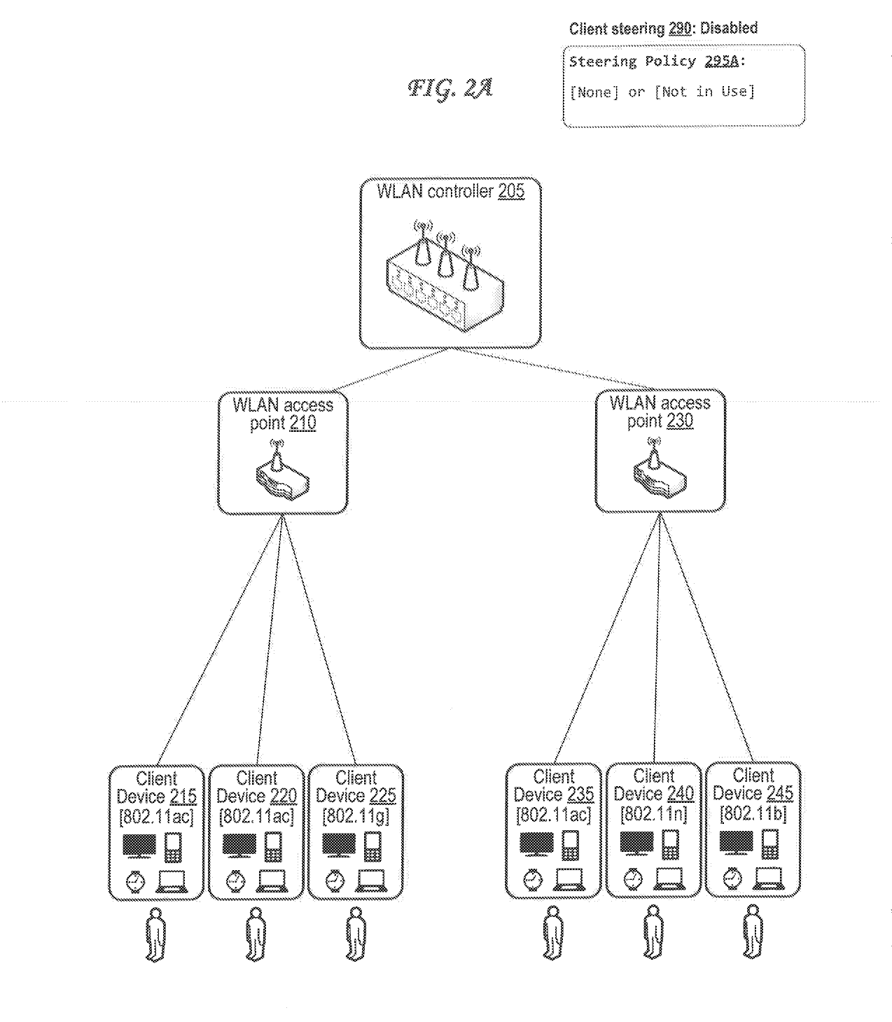

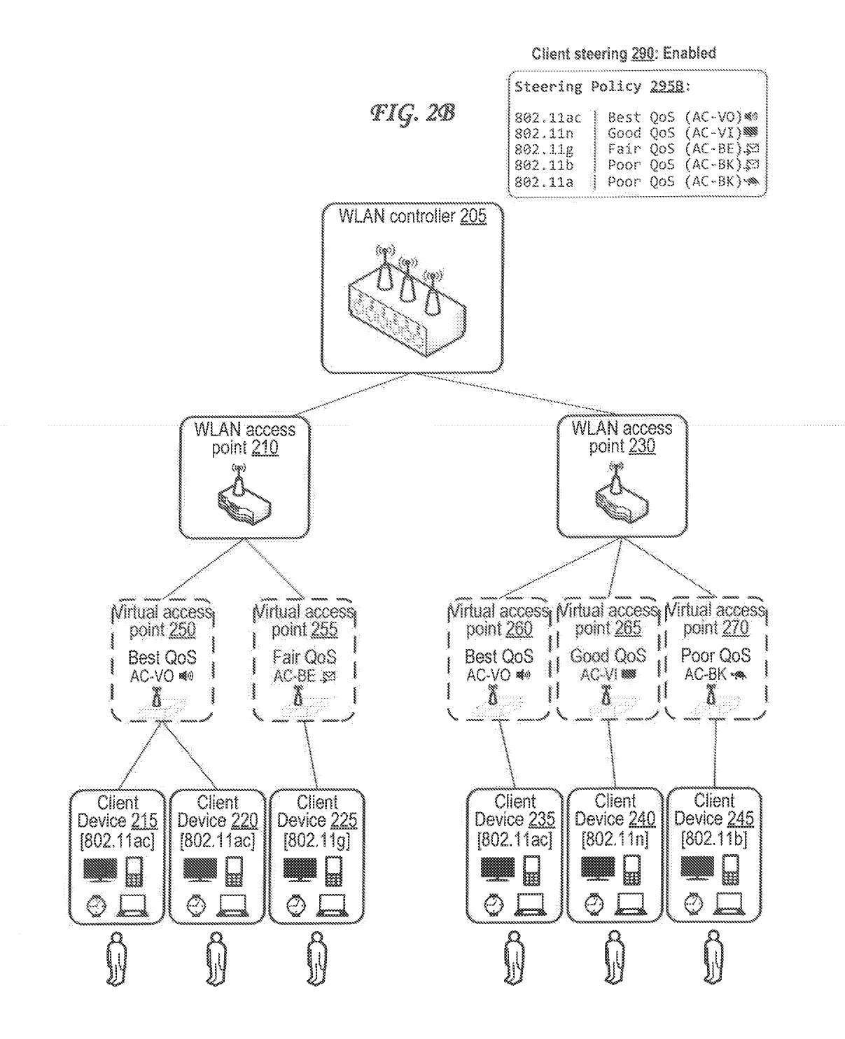

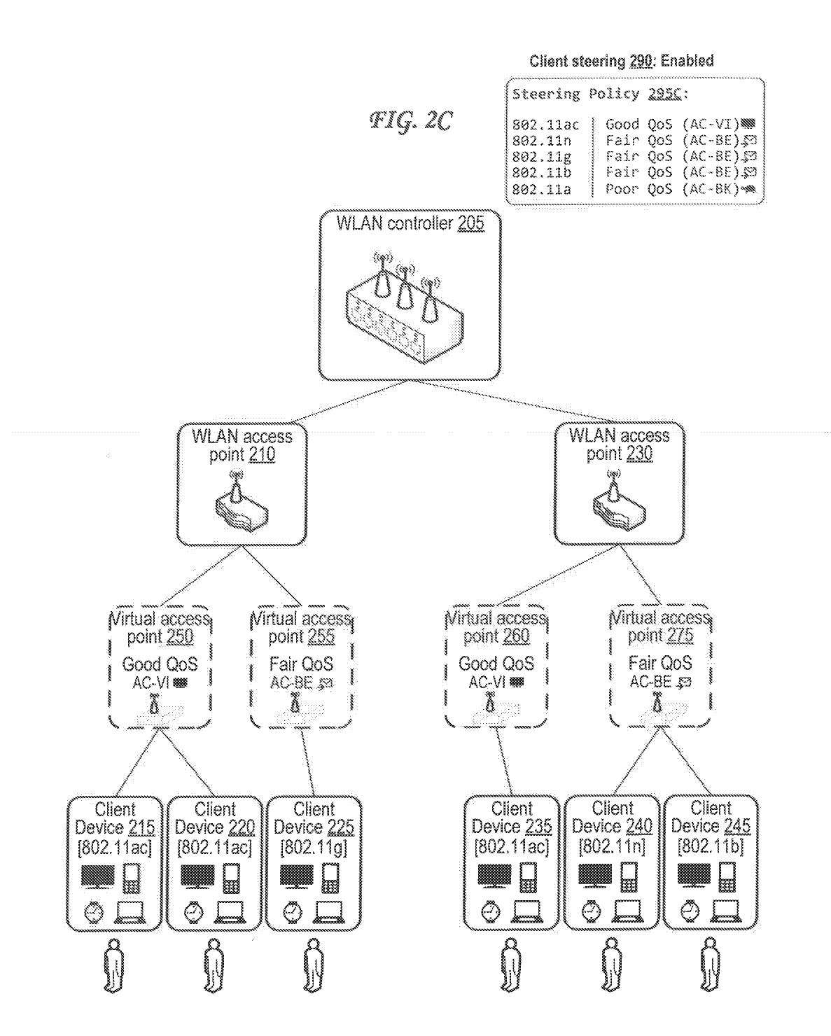

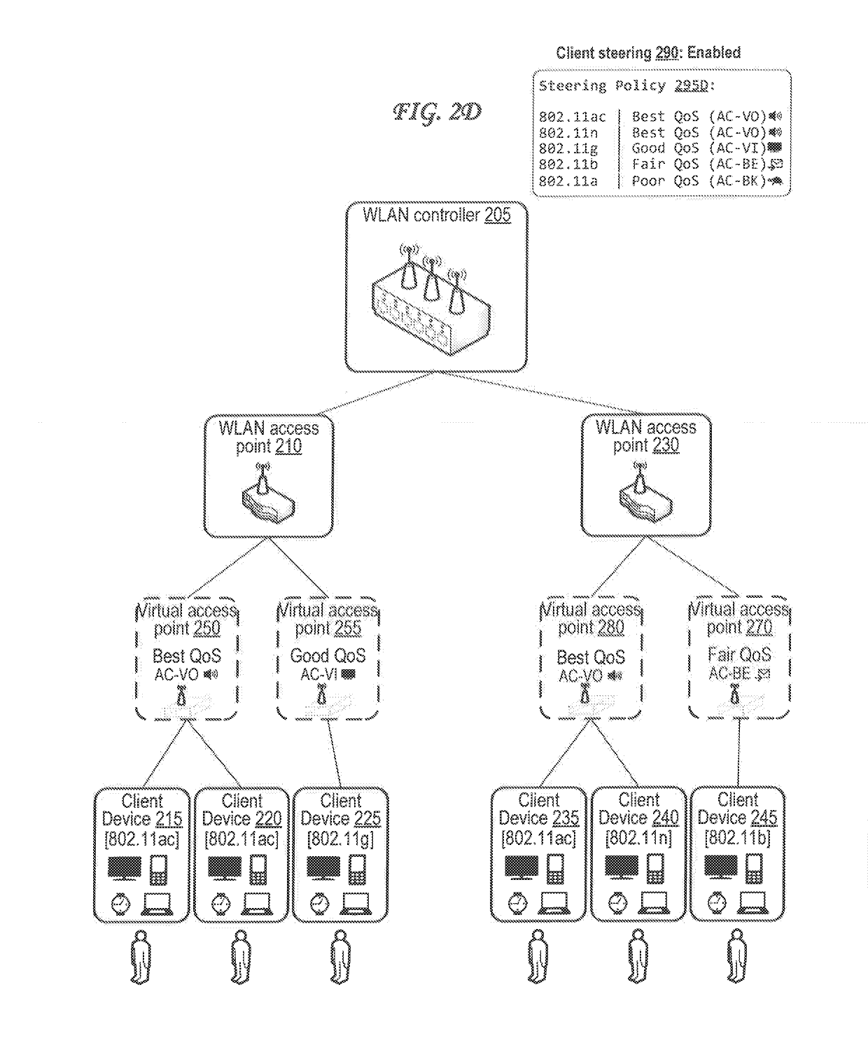

FIG. 2A illustrates an exemplary wireless local area network (WLAN) environment with client steering disabled.

The exemplary wireless local area network (WLAN) environment of FIG. 2A includes a single WLAN controller 205 communicatively coupled (e.g. via wires, wireless connections, or some combination thereof) to two physical WLAN access points (i.e., WLAN access point 210 and WLAN access point 230).

The WLAN access point 210 is wirelessly communicatively coupled to three client devices, namely: a client device 215 that uses 802.11ac, a client device 220 that also uses 802.11ac, and a client device 225 that uses 802.11g. The WLAN access point 230 is wirelessly communicatively coupled to three other client devices, namely: a client device 235 that uses 802.11 ac, a client device 240 that uses 802.11n, and a client device 245 that uses 802.11b. In an alternate embodiment, one or both of the WLAN access point 210 or WLAN access point 215 can be virtual access points generated by the WLAN controller 205

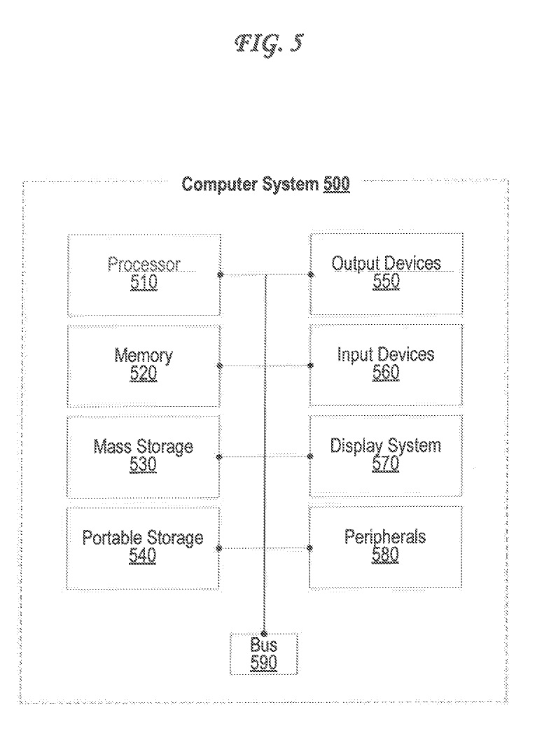

The client devices may each be any type of computer system 500, or may be any type of device that includes at least a subset of the computer system components illustrated in FIG. 5 (e.g., processor 510, memory 520, mass storage 530, portable storage 540, output devices 550, input devices 560, display system 570, peripherals 580). For example, the client devices may be desktop computers, laptop computers, wearable devices, cellular telephone devices, “smartphone” devices, tablet devices, television sets, home media center devices, portable media player devices, home video game consoles, portable video game consoles, or some combination thereof. Each client device may in some cases be or include a virtual machine, and may each in some cases include or control multiple other devices (not shown) coupled via network connections.

Client steering 290 is disabled as illustrated in FIG. 2A, meaning that WLAN access point 210 and WLAN access point 230 have not generated any virtual access points (VAP), or if they have, they are not being used for client steering purposes. Client steering may be disabled when the WLAN controller 205 does not support generation and/or transmission of client steering policies, or has simply failed to generate and/or transmit a client steering policy (e.g., due to an error). Client steering may be disabled when the WLAN controller 205 does not support generation and/or transmission of client steering policies in the correct format (e.g., one that can be interpreted by WLAN access point 210 and/or WLAN access point 230). WLAN access point 210 and/or WLAN access point 230 do not support receiving or interpreting a client steering policy transmitted by the WLAN controller 205 (e.g., does not support client steering entirely or is incompatible with a client steering policy format used by WLAN controller 205) or has simply failed to receive a client steering policy (e.g., due to a network error) or failed to properly interpret a client steering policy (e.g., due to an internal error). Client steering may also be disabled via a client steering policy that identifies that client steering is to be disabled, or the client steering policy is determined by a WLAN access point to be ineffectual and is discarded (e.g., client steering policy indicates that a single identical quality of service is to be granted to all client devices). Client steering may also be disabled if settings at the WLAN access point 210 and/or WLAN access point 230 indicate that al (or a subset of) client steering policies received from WLAN controller 205 are to be disregarded.

FIG. 2B illustrates an exemplary wireless local area network (WLAN) environment with client steering enabled and with a first steering policy.

The exemplary wireless local area network (WLAN) environment of FIG. 2B includes the same WLAN controller 205 communicatively coupled to physical WLAN access point 210 and physical WLAN access point 230, and also includes the same client devices (i.e., 802.11ac client device 215, 802.11ac client device 220, 802.11g client device 225, 802.11ac client device 235, 802.11n client device 240, 802.11b client device 245) as described in FIG. 2A.

The difference between the WLAN environment of FIG. 2A and the WLAN environment of FIG. 2B is that the WLAN environment of FIG. 2B includes a layer of virtual access points (“VAPs”) (250/255/260/265/270) between the physical WLAN access points (210/230) and their respective client devices (215/220/225/235/240/245). These virtual access points are generated according to a steering policy 295B transmitted from the WLAN controller 205 to WLAN access point 210 and to WLAN access point 230.

The steering policy 295B of FIG. 2B identifies different quality of service (QoS) levels based on the data rate capabilities 170 of each client device. There are four quality of service (QoS) levels identified in FIG. 2B, which follow the four WiFi Multimedia (WMM) standard quality of service (QoS) levels—the best quality of service level being the “voice data” quality of service level (“AC-VO”), followed by the good “video data” quality of service level (“AC-VI”), followed by the fair “best-effort data” quality of service level (“AC-BE”), finally followed by the poor “background data” quality of service level (“AC-BK”). It should be understood that future standards may implement different quality of service level standards (e.g., additional or entirely different quality of service levels), which may be substituted in place of the four WiFi Multimedia (WMM) standard quality of service (QoS) levels.

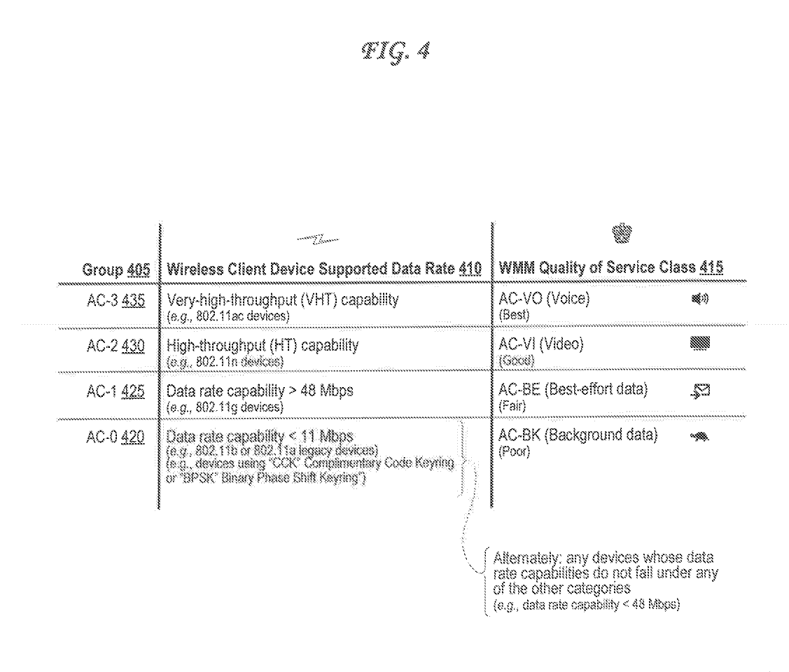

In particular, the steering policy 295B of FIG. 2B identifies that client devices with one or more specifications matching the 802.11ac standard should be granted the best quality of service (AC-VO), client devices with one or more specifications matching the 802.11n standard should be granted the good quality of service (AC-VI), client devices with one or more specifications matching the 802.11g standard should be granted the fair quality of service (AC-BE), and client devices with one or more specifications matching the 802.11b or 802.11a standards should be granted the poor quality of service (AC-BK). The steering policy 295B of FIG. 2B is similar to the steering policy identified in FIG. 4.

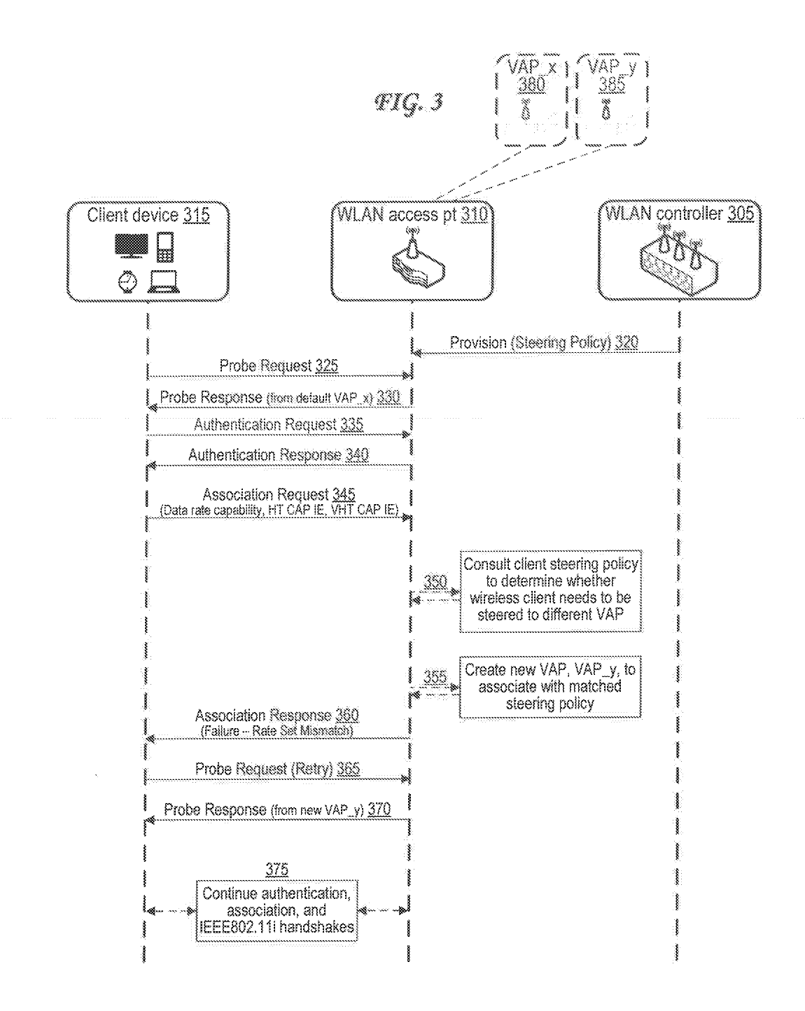

Client device connections are steered (e.g., see steering process of FIG. 3) so that each virtual access point serves client devices that are to be granted the same quality of service. This allows easier and more efficient segregation of traffic from and/or to a number of client devices with a diverse range of data rate capabilities 170, and allows for the type of prioritization of requests illustrated in the efficient data prioritization 185 of FIG. 2B.

Physical WLAN access point 210 is illustrated in FIG. 2A as having generated two virtual access points. The first of these is virtual access point 250, which uses the best quality of service (AC-VO), and which is wirelessly connected to client devices 215 and 220, whose data rate capabilities 170 match the 802.11ac standard. The second of these virtual access points is virtual access point 255, which the fair quality of service (AC-BE), and which is wirelessly connected to client device 225, whose data rate capabilities 170 match the 802.11g standard.

Physical WLAN access point 230 is illustrated in FIG. 2A as having generated three virtual access points. The first of these is virtual access point 260, which uses the best quality of service (AC-VO), and which is wirelessly connected to client device 235, whose data rate capabilities 170 match the 802.11ac standard. The second of these virtual access points is virtual access point 265, which uses the good quality of service (AC-VI), and which is wirelessly connected to client device 240, whose data rate capabilities 170 match the 802.11n standard. The third of these virtual access points is virtual access point 270, which uses the poor quality of service (AC-BK), and which is wirelessly connected to client device 245, whose data rate capabilities 170 match the legacy 802.11b standard.

FIG. 2C illustrates an exemplary wireless local area network (WLAN) environment with client steering enabled and with a second steering policy.

The steering policy 295C of FIG. 2C grants different quality of service levels to different data rate capabilities than steering policy 295B of FIG. 2B. In particular, the steering policy 295C of FIG. 2C identifies that client devices with one or more specifications matching the 802.11ac standard should be granted the good quality of service (AC-VI), client devices with one or more specifications matching the 802.11n or 802.11g or 802.11b standards should be granted the fair quality of service (AC-BE), and client devices with one or more specifications matching the 802.11a standard should be granted the poor quality of service (AC-BK).

The steering policy 295C of FIG. 2C notably does not identify use of the best quality of service (AC-VO), making the steering policy 295C of FIG. 2C useful when client devices with even higher data rate capabilities are expected to be introduced (e.g., client devices whose data rate capabilities match the 802.11ad standard), which may then be granted the best quality of service (AC-VO).

In accordance with the steering policy 295C of FIG. 2C, the WLAN access point 210 of FIG. 2C retains virtual access point 250, which remains wireless connected to client devices 215 and 220 (with one or more specifications matching the 802.11ac standard), though virtual access point 250 now uses the good quality of service (AC-VI). Virtual access point 255 is likewise retained and is still wirelessly connected to client device 225 (with one or more specifications matching the 802.11g standard), and still uses the fair quality of service (AC-BE).

In accordance with the steering policy 295C of FIG. 2C, the WLAN access point 230 of FIG. 2C retains virtual access point 260, which remains wireless connected to client device 235 (with one or more specifications matching the 802.11ac standard), though virtual access point 260 now uses the good quality of service (AC-VI). Virtual access points 265 and 270 of FIG. 2B are now replaced by virtual access point 275, which is wirelessly connected to client devices 240 and 245 (with one or more specifications matching the 802.11n standard and 802.11b standard, respectively), and which uses the fair quality of service (AC-BE).

FIG. 2D illustrates an exemplary wireless local area network (WLAN) environment with client steering enabled and with a third steering policy.

The steering policy 295D of FIG. 2D grants different quality of service levels to different data rate capabilities than steering policy 295B of FIG. 2B and steering policy 295C of FIG. 2C. In particular, the steering policy 295D of FIG. 2D identifies that client devices with one or more specifications matching the 802.11ac or 802.11n standards should be granted the best quality of service (AC-VO), client devices with one or more specifications matching the 802.11g standard should be granted the good quality of service (AC-VI), client devices with one or more specifications matching the 802.11b standard should be granted the fair quality of service (AC-BE), and client devices with one or more specifications matching the 802.11a standard should be granted the poor quality of service (AC-BK).

By allocating the best quality of service (AC-VO) to client devices matching both 802.11ac and 802.11n, the steering policy 295D of FIG. 2D allows, for example, for client devices to be introduced with specifications matching additional lower data rate capability standards, such as 802.11ah or 802.11af (which are slower by design due to a focus on longer-range transmission capabilities). Devices matching such standards may then be slotted into the steering policy 295D of FIG. 2D and may be granted good quality of service (AC-VI), fair quality of service (AC-BE), or poor quality of service (AC-BK) as appropriate (e.g., depending on how the data rate capabilities 170 of those standards compare with established and commonly used standards such as 802.11a, 802.11b, 802.11g, 802.11n, or 802.11ac).

In accordance with the steering policy 295D of FIG. 2D, the WLAN access point 210 of FIG. 2D retains virtual access point 250, which remains wireless connected to client devices 215 and 220 (with one or more specifications matching the 802.11ac standard), and uses the best quality of service (AC-VO) as it did in FIG. 2B. Virtual access point 255 is likewise retained and is still wirelessly connected to client device 225 (with one or more specifications matching the 802.11g standard), and now uses the good quality of service (AC-VI).

In accordance with the steering policy 295D of FIG. 2D, the WLAN access point 230 of FIG. 2C retains virtual access point 270 which remains wireless connected to client device 245 (with one or more specifications matching the 802.11b standard), though virtual access point 245 now uses the fair quality of service (AC-BE). Virtual access points 260 and 265 of FIG. 2B are now replaced by virtual access point 280, which is wirelessly connected to client devices 235 and 240 (with one or more specifications matching the 802.11ac standard and 802.11n standard, respectively), and which uses the best quality of service (AC-VO).

The WLAN environment illustrated in FIG. 2A, FIG. 2B, FIG. 2C, and FIG. 2D may have even more alternate layouts of various virtual access points based on different variations in the steering policy 295. The steering policy 295B of FIG. 2B, the steering policy 295C of FIG. 2C, and the steering policy 295D of FIG. 2D are to be interpreted as examples rather than limitations.

FIG. 3 is a swim-lane flow diagram illustrating exemplary client steering operations between a wireless local area network (WLAN) controller, a wireless access point (AP), and a client device. The WLAN controller 305 is communicatively coupled (e.g., via wires, wireless connections, or some combination thereof) to the physical WLAN access point 310. The physical WLAN access point 310 is wirelessly communicatively coupled to the client device 315.

At step 320, the WLAN controller 305 provisions the steering policy to the access point 310. The steering policy provisioning of step 320 may occur automatically when the access point 310 is communicatively coupled to the WLAN controller 305, or may occur automatically, periodically, or manually (e.g., via command from a network administrator) at a later time. The steering policy may identify whether client steering is enabled or disabled, may identify whether clustering is enabled or disabled (e.g., and if it is enabled, then how), and may finally a table or database (e.g., as in FIG. 4) identifying what quality of service (QoS) level should be provided by each virtual access point of that access point 310.

The WLAN controller 305 may periodically or manually (e.g., via command from a network administrator) re-provision the steering policy to the access point 310 in order to update the steering policy (e.g., to enable/disable steering 290, to adjust assignments of quality of service levels to different data rate capabilities matching different standards). For example, different steering policies may be used at different times of day (or particular days of the week/month/year) to deal with surges in network traffic or surges in particular types (e.g., particular wireless protocols) of network traffic.

At step 325, the client device 315 transmits a probe request to a service set identification (SSID) corresponding to the access point 310. The access point 310 directs this prove request to a “default” virtual access point, VAP_x 380.

At step 330, the access point 310 replies to the client device 315 with a probe response from the “default” virtual access point, VAP_x 380.

At step 335, the client device 315 transmits an authentication request to the access point 310 and in particular to the “default” virtual access point, VAP_x 380.

At step 340, the access point 310 transmits an authentication response that is received by the client device 315.

At step 345, the client device 315 transmits an association request to the access point 310, and in particular to the “default” virtual access point, VAP_x 380. The association request of step 345 includes information about the client device 315, and may for example include a data rate capability 170 information element (IE), which may be referred to in some cases as a “basic supported rate” information element or a “basic service rate” information element. For example, a client using 802.11n typically transmits a “High Throughput” (HT) Capability information element, and a client using 802.11ac typically transmits a “Very High Throughput” (VHT) Capability information element.

At step 350, the WLAN access point 310 consults the steering policy it received from the WLAN controller in step 320 to determine whether the “default” virtual access point VAP_x 380 is appropriate for the client device 315 or whether the client device 315 should be steered to a different virtual access point. If VAP_x 380 is appropriate for the client device 315 (e.g., the quality of service of the virtual access point matches the data rate capability 170 of the client device 315), then the client device 315 can be connected to VAP_x 380 (not shown in FIG. 3). If not, then the process moves on to step 355.

At step 355, the WLAN access point 310 generates a new virtual access point, VAP_y 385, to associate with the client device 315 so that the quality of service of VAP_y 385 matches the data rate capability 170 of the client device 315 as dictated by the steering policy 320. An alternate step (not pictured) in place of step 355 might instead identify an already-generated virtual access point VAP_y 385 whose quality of service matches the data rate capability 170 of the client device 315 as dictated by the steering policy 320.

At step 360, the WLAN access point 310 transmits an association response back to the client device 315, the association response indicating a failure (e.g., by reason of rate set mismatch). This prevents the client device 315 from connecting to the “default” virtual access point VAP_x 380.

At step 365, the client device 315 sends another probe request to the access point 310 to retry forming a connection to the access point 310.

At step 370, the access point 310 sends a new probe response from the new virtual access point VAP_y 385 that was generated in step 355.

At step 375, the access point 310 and the client device 315 continue with authentication, association, and handshakes (e.g., according to IEEE 802.11i standards) and any other necessary operations for the client device 315 to connect to the virtual access point VAP_y 385 of the physical access point 310.

FIG. 4 is a table illustrating an exemplary client steering policy identifying various quality of service (QoS) groupings.

The client steering policy table of FIG. 4 identifies four quality of service (QoS) classes standardized according to the WiFi Multimedia (WMM) standards similarly to the client steering policies 295B, 295C, and 295D of FIG. 2B, FIG. 2C, and FIG. 2D. In particular, the four quality of service (QoS) classes are, in descending order of quality of service (QoS), Voice Data (“AC-VO”) (see row AC-3 435), Video Data (“AC-VI”) (see row AC-2 430), Best-Effort Data (“AC-BE”) (see row AC-1 425), and Background Data (“AC-BK”) (see row AC-0 420).

Priority can be granted to client devices according to data rate capabilities 170 of wirelessly connected client devices. For example, a client device with very-high-throughput (VHT) capability (e.g., a 802.11ac client device) may be given the best quality of service by getting Voice Data (“AC-VO”) quality of service (see row AC-3 435). A client device with high-throughput (HT) capability but without VHT capability (e.g., a 802.11n client device) may be given the good quality of service by getting Video Data (“AC-VI”) quality of service (see row AC-2 430). A client device with a data rate capability 170 greater than 48 Mbps but without HT or VHT capability (e.g., a 802.11g client device) may be given the fair quality of service by getting Best-Effort Data (“AC-BE”) quality of service (see row AC-1 425). A client device with a data rate capability 170 lower than 11 Mbps (e.g., a 802.11b or 802.11a client device) may be given the poor quality of service by getting Background Data (“AC-BK”) quality of service (see row AC-1420).

Alternately, the poor quality of service (“AC-BK”) (see row AC-0 420) may be granted to any device whose capabilities do not fit under any of the other data rate capability categories. Thus, any device with a data rate capability of less than 48 Mbps might be granted poor quality of service (“AC-BK”) under such a client steering policy.

A steering policy of a WLAN controller 305 may include additional categories of information that are not illustrated in FIG. 4 (e.g., identifying type of device) or may include less information than is illustrated in FIG. 4 (e.g., removing the “group” column 405. While the steering policies of FIG. 2B, FIG. 2C, and FIG. 2D more explicitly identify device standards (e.g., 802.11ac devices, 802.11n devices, 802.11g devices, 802.11b devise, 802.11a devices), the steering policy represented in FIG. 4 instead identifies particular capabilities, for example in throughput or data rate values, such as values measured in Megabits per second (Mbps) or Gigabits per second (Gbps).

FIG. 5 is a block diagram of an exemplary computing device that may be used to implement an embodiment of the present invention. FIG. 5 illustrates an exemplary computing system 500 that may be used to implement an embodiment of the present invention. For example, any of the computer systems or computerized devices described herein (e.g., WLAN controller 305/205, access point 310/210/230, client device 315/215/220/225/235/240/245) may, in at least some cases, be a computing system 500, or may include at least a subset of the elements of the computing system 500 illustrated in FIG. 5. The computing system 500 of FIG. 5 includes one or more processors 510 and memory 510. Main memory 510 stores, in part, instructions and data for execution by processor 510. Main memory 510 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 510 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 510.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD), a plasma display, an organic light-emitting diode (OLED) display, an electronic ink display, a projector-based display, a holographic display, or another suitable display device. Display system 570 receives textual and graphical information, and processes the information for output to the display device. The display system 570 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer system 500 may in some cases be a virtual computer system executed by another computer system. The computer can also include different bus configurations, networked platforms, multi-processor platforms, etc. Various operating systems can be used including Unix, Linux, Windows, Macintosh OS, Palm OS, Android, iOS, and other suitable operating systems.

In some cases, the computer system 500 may be part of a multi-computer system that uses multiple computer systems 500 (e.g., for one or more specific tasks or purposes). For example, the multi-computer system may include multiple computer systems 400 communicatively coupled together via one or more private networks (e.g., at least one LAN, WLAN, MAN, or WAN), or may include multiple computer systems 500 communicatively coupled together via the internet (e.g., a “distributed” system), or some combination thereof.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A method for wireless network optimization, the method comprising:
receiving a steering policy that identifies matches between a plurality of data rate capabilities and a plurality of quality of service levels;
receiving an association request from a client device, the association request identifying at least a client data rate capability of the client device;
identifying, based on the received steering policy, a client quality of service level matching the client data rate capability;
identifying a matching-quality virtual access point having a virtual access point quality of service level that matches the client quality of service level; and
initiating wireless communications between the client device and the matching-quality virtual access point.

2. The method of claim 1, wherein the association request is directed at the matching-quality virtual access point.

3. The method of claim 1, wherein the association request is not directed at the matching-quality virtual access point.

4. The method of claim 3, wherein the association request is directed at a second virtual access point that is distinct from the matching-quality virtual access point.

5. The method of claim 3, further comprising:
transmitting an association response to the client device, the association response indicating failure;
receiving a probe request from the client device prior to initiating wireless communications; and
transmitting a probe response associated with the matching-quality virtual access point to the client device.

6. The method of claim 1, wherein initiating wireless communications between the client device and the matching-quality virtual access point includes performing at least one of an authentication, an association, or a handshake.

7. The method of claim 1, wherein the matching quality of service level is one of a background data quality of service level, a best-effort data quality of service level, a video data quality of service level, or a voice data quality of service level.

8. The method of claim 1, wherein the client data rate capability of the client device matches a wireless data communication standard, the wireless data communication standard being one of IEEE 802.11a, IEEE 802.11b, IEEE 802.11g, IEEE 802.11n, IEEE 802.11ac, IEEE 802.11af, IEEE 802.11ah, IEEE 802.11ai, IEEE 802.11aj, IEEE 802.11aq, IEEE 802.11ax, IEEE 802.11ay, or some combination thereof.

9. The method of claim 8, wherein the matching-quality virtual access point is communicatively coupled to one or more other client devices whose respective data rate capabilities also match the wireless data communication standard.

10. The method of claim 1, further comprising generating the matching-quality virtual access point so that the virtual access point quality of service level of the matching-quality virtual access point matches the client quality of service level.

11. The method of claim 1, wherein initiating wireless communications between the client device and the matching-quality virtual access point includes communicating in mixed mode.

12. The method of claim 1, wherein the client quality of service level is a WiFi Multimedia (WMM) quality of service level, the WiFi Multimedia (WMM) quality of service level being one of a voice quality of service level (AC-VO), a video quality of service level (AC-VI), a best-effort quality of service level (AC-BE), or a background quality of service level (AC-BK).

13. The method of claim 1, further comprising prioritizing communications passing through the matching-quality virtual access point over communications passing through a second virtual access point with a lower quality of service level than the client quality of service level.

14. The method of claim 1, further comprising prioritizing communications passing through a second virtual access point over communications passing through the matching-quality virtual access point, wherein the second virtual access point has a higher quality of service level than the client quality of service level.

15. A system for wireless network optimization, the system comprising:
a communication transceiver, the communication transceiver communicatively coupled to at least a network controller and client device, the communication transceiver to receive a steering policy from the network controller, the steering policy identifying matches between a plurality of data rate capabilities and a plurality of quality of service levels, the communication transceiver to receive an association request from the client device, the association request identifying at least a client data rate capability of the client device;
a memory; and
a processor coupled to the memory and to the communication transceiver, wherein execution of instructions stored in the memory by the processor:
identifies, based on the received steering policy, a client quality of service level matching the client data rate capability,
identifies a matching-quality virtual access point having a virtual access point quality of service level that matches the client quality of service level, and
initiates wireless communications between the client device and the matching-quality virtual access point.

16. The system of claim 15, wherein the association request is directed at the matching-quality virtual access point.

17. The system of claim 15, wherein the association request is not directed at the matching-quality virtual access point.

18. The system of claim 15, wherein the client data rate capability of the client device matches a wireless data communication standard, the wireless data communication standard being one of IEEE 802.11a, IEEE 802.11b, IEEE 802.11g, IEEE 802.11n, IEEE 802.11ac, IEEE 802.11af, IEEE 802.11ah, IEEE 802.11ai, IEEE 802.11aj, IEEE 802.11aq, IEEE 802.11ax, IEEE 802.11ay, or some combination thereof.

19. The system of claim 15, wherein the client quality of service level is a WiFi Multimedia (WMM) quality of service level, the WiFi Multimedia (WMM) quality of service level being one of a voice quality of service level (AC-VO), a video quality of service level (AC-VI), a best-effort quality of service level (AC-BE), or a background quality of service level (AC-BK).

20. A non-transitory computer-readable storage medium, having embodied thereon a program executable by a processor to perform a method for wireless network optimization, the method comprising:
receiving a steering policy that identifies matches between a plurality of data rate capabilities and a plurality of quality of service levels;
receiving an association request from a client device, the association request identifying at least a client data rate capability of the client device;
identifying, based on the received steering policy, a client quality of service level matching the client data rate capability;
identifying a matching-quality virtual access point having a virtual access point quality of service level that matches the client quality of service level; and
initiating wireless communications between the client device and the matching-quality virtual access point.
